(19) United States
(12) Patent Application Publication
(10) Pub. No.: US 2016/0171910 A1
(43) Pub. Date: Jun. 16, 2016

(54) METHOD OF DISPLAYING EXISTENCE PROBABILITY OF ELECTRON IN HYDROGEN ATOM

(71) Applicant: Haruo Matsushima, Yamatokoorlyama-shi (JP)

(72) Inventor: Haruo Matsushima, Yamatokoorlyama-shi (JP)

(21) Appl. No.: 14/991,381

(22) Filed: Jan. 8, 2016

Related U.S. Application Data
(63) Continuation of application No. 14/593,121, filed on Jan. 9, 2015.

(30) Foreign Application Priority Data
Apr. 22, 2014 (JP) 2014-099993

(51) Int. Cl. G09B 23/20

(52) U.S. Cl. CPC G09B 23/20

(57) ABSTRACT

Disclosed herein is a method of displaying an existence probability of an electron in a hydrogen atom. In the method, N radii are referred to as r₁ to r_{N} in ascending order. An area proportional to the surface area of a sphere having a radius rₙ (n is any of 1 to N) is referred to as Sₙ. A value proportional to an existence probability of an electron at a distance rₙ from the center of a hydrogen atom is referred to as Pₙ. The method includes displaying a circle having an area Sₙ for all n from 1 to N in a concentric manner, and displaying small symbols which are Pₙ in number on the circle having the area Sₙ in an equally spaced manner for all n from 1 to N and in such a manner that small symbols associated with a circle having a larger radius is partly hidden behind a circle having a smaller radius.

### CROSS-REFERENCE STATEMENT

This application is a continuation of U.S. patent application Ser. No. 14/593,121, filed Jan. 9, 2015, which is based on Japanese patent application serial No. 2014-099993, filed with Japan Patent Office on Apr. 22, 2014. The whole content of the applications are hereby incorporated by reference.

### BACKGROUND OF THE INVENTION

1. Field of the Invention

The present invention relates to an improvement of a method of displaying an existence probability of an electron in a hydrogen atom as a scientific educational tool.

2. Description of Related Art

As to a method of displaying an existence probability of an electron in a hydrogen atom, a graph of radial distribution shown in FIG. 3 can be seen in many of textbooks and is well known as very ABCs of quantum mechanics. There are also known graphs of qualitative plane (i.e., two-dimensional) distributions shown in FIGS. 4A and 4B, a graph of qualitative stereo (i.e., three-dimensional) distribution shown in FIG. 5 and the like.

It is, however, said that the probability interpretation of quantum mechanics was opposed by many of academics in a period of foundation, such as the father Shroedinger, Einstein and others. In such a circumstance, there is desired an educational tool that provides various information on the process of theory construction, its basis and the like. Since a wave function is expressed by three-dimensional coordinates, a quantitative stereo distribution of the existence probability can be expressed from the beginning. Nevertheless, there is known only a simple sphere like FIG. 5 as a three-dimensional expression.

### BRIEF SUMMARY OF THE INVENTION

The present invention solves the above-mentioned conventional problem and provides a method of quantitatively displaying a three-dimensional existence probability of an electron in a hydrogen atom as a scientific educational tool.

One embodiment of the present invention, to achieve the above-mentioned object, is a method of displaying an existence probability of an electron in a hydrogen atom. The method, referring to n radii as r1 to rn in ascending order, to an area proportional to a surface area of a sphere having a radius rn as Sn, and to a value proportional to an existence probability of an electron at a distance rn from the center of a hydrogen atom as Pn, places small symbols which are Pn in number on a figure having an area Sn in an equally spaced manner, or equally divides the area Sn into Pn sections. The method displays the small symbols or the divided sections for all of 1 to n in a manner of placing together.

Since the method of displaying an existence probability of an electron in a hydrogen atom as an educational tool according to one embodiment of the present invention, referring to n radii as r1 to rn in ascending order, to an area proportional to a surface area of a sphere having a radius rn as Sn, and to a value proportional to an existence probability of an electron at a distance rn from the center of a hydrogen atom as Pn, places small symbols which are Pn in number on a figure having an area Sn in an equally spaced manner, or equally divides the area Sn into Pn sections, and displays the small symbols or the divided sections for all of 1 to n in a manner of placing together, the method is useful in understanding of the existence probability which is very basics of quantum mechanics and inspires interest in studying science.

### BRIEF DESCRIPTION OF THE DRAWINGS

FIG. 1 is a plan view showing an existence probability of an electron in a is orbital of a hydrogen atom according to a first embodiment of the present invention;

FIGS. 2A to 2C are exploded and enlarged views of the central area of FIG. 1;

FIG. 3 is a graph showing existence probabilities of an electron in 1s and 2s orbitals of a hydrogen atom along a radial direction according to conventional art.

FIGS. 4A and 4B are two-dimensional views showing existence probabilities of an electron in 1s and 2s orbitals of a hydrogen atom respectively according to conventional art.

FIG. 5 is a three-dimensional view showing existence probability of an electron in a 1s orbital of a hydrogen atom according to conventional art.

### DESCRIPTION OF THE PREFERRED EMBODIMENTS

Hereinafter, preferred embodiments of the present invention will be described. N radii are referred to as r1 to rn in ascending order. An area proportional to the surface area of a sphere having a radius rn is referred to as Sn. A value proportional to existence probability of an electron at a distance rn from the center of a hydrogen atom is referred to as Pn. Small symbols which are Pn in number are placed on a figure having an area Sn in an equally spaced manner. The small symbols are displayed for all of 1 to n in a manner of being placed together. This display method is referred to as the first embodiment of the present invention. The second embodiment of the present invention, instead, equally divides the area Sn into Pn sections, and displays the divided sections for all of 1 to n on the spheres having radii r1 to rn placed in a concentric manner.

### Example

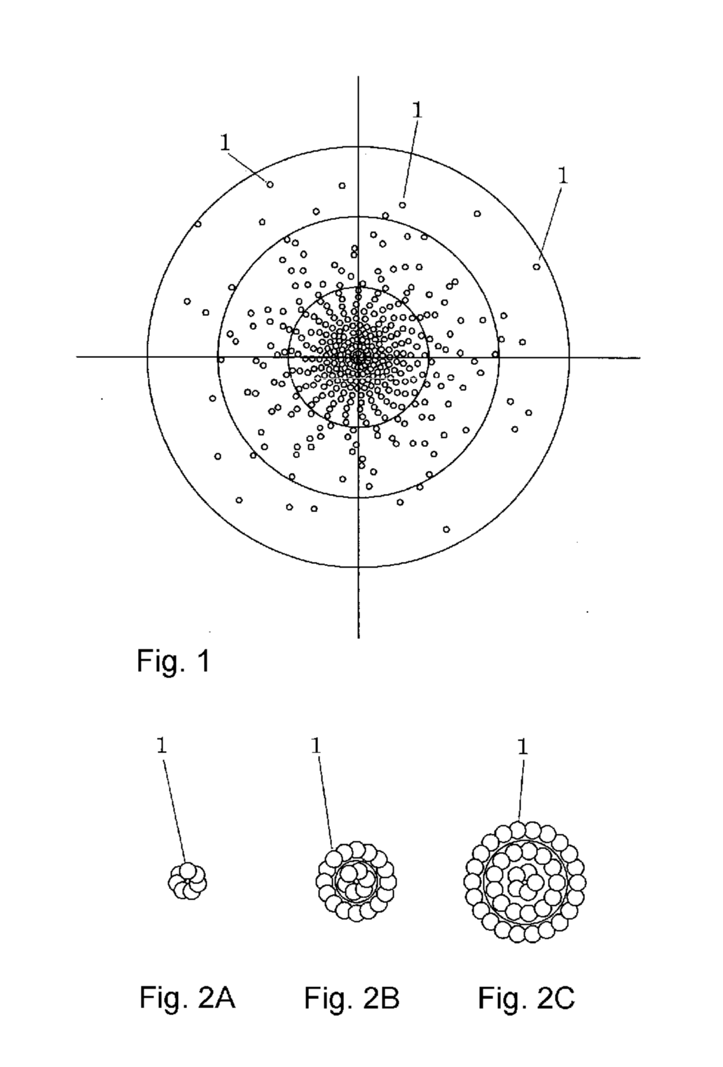

FIG. 1 illustrates the method of displaying the existence probability of an electron in a 1s orbital of a hydrogen atom as an educational tool according to the first embodiment of the present invention. There are displayed concentric circles having areas proportional to surface areas of spheres having radii varying from 0.1 to 3.0 with 0.1 increments in between with Bohr radius set at 1 (i.e., a₀=1). There are further placed small symbols whose number is proportional to an existence probability of an electron at a corresponding radius on each of the circles. The procedure to provide the display will hereinafter be described with reference to following Table 1.

TABLE 1

| radius r | 0.1 | 0.2 | 0.3 | 0.4 | | 0.5 | 0.6 | 0.7 |
|---|---|---|---|---|---|---|---|---|
| SurfArSphe*¹ = 4π r² | 0.125 | 0.502 | 1.131 | 2.01 | | 3.141 | 4.524 | 6.158 |
| ExPrb*² = r² exp(−2r) | 0.0081 | 0.0268 | 0.0493 | 0.0718 | | 0.0919 | 0.1084 | 0.1208 |
| accumulation | 0.0081 | 0.035 | 0.0843 | 0.1562 | | 0.2482 | 0.3566 | 0.4775 |
| per 2000 | 6.5 | 21.5 | 39.5 | 57.5 | | 73.6 | 86.7 | 96.7 |
| Id. (visible portion) | 7 | 16 | 22 | 25 | | 26 | 26 | 26 |
| 0.8 | 0.9 | 1.0 | 1.1 | 1.2 | 1.5 | 3.0 | 6.0 | 6.1 |
| 8.043 | 10.17 | 12.56 | 15.2 | 18.09 | 28.27 | 113.1 | 452.4 | 467.4 |
| 0.1292 | 0.1338 | 0.1353 | 0.1340 | 0.1306 | 0.1196 | 0.0992 | 0.0009 | 0.0001 |
| 0.6067 | 0.7406 | 0.8759 | 1.0100 | 1.1406 | 1.4973 | 2.3559 | 2.4987 | 2.4989 |
| 103.4 | 107.1 | 108.3 | 107.3 | 104.5 | 89.6 | 17.8 | 0.0 | 0.0 |
| 24 | 22 | 21 | 19 | 17 | 12 | 1 | 0 | 0 |

*¹SurfArSphr: surface area of sphere
*²ExPrb: existence probability

Table 1 shows part of a set of data prepared by use of spreadsheet software for a personal computer. Part of the preparation procedure that seems to belong to common knowledge of a person skilled in the art is omitted. There are arranged radii r from 0.1 to around 7.0 with 0.1 increments in between in the first row; sphere surface areas 4πr² in the second row; existence probabilities r²exp(−2r) with a normalization coefficient omitted in the third row; accumulative values of the existence probabilities from radius 0.1 to r in the fourth row; the values in the third row divided by a convergent value 2.5, multiplied by 2000 so as to be expressed by per 2000 and further rounded to one decimal place in the fifth row; and the existence probabilities at the radius r multiplied by a value obtained by dividing the surface area of a sphere to its immediate left by the surface area of a sphere having the same radius r so as to be expressed by per 2000 in a visible portion and further rounded to the whole number in the sixth row. The reason why the radii are limited only up to around 7.0 is that the existence probabilities become almost zero at radii over around 6, and as a result, the accumulative values in the fourth row converge. The reason why the normalization coefficient is omitted from the existence probabilities is that the coefficient is not needed for the calculation of the values expressed by per 2000.

FIGS. 2A to 2C will be explained in first as needed for explanation of visible portions arranged in the sixth row. FIG. 2A displays a circle having a radius of around 4 mm which expresses a sphere having a radius r=0.1, and 7 small circles having a little smaller in a diameter than 4 mm placed on the circumference of a circle having a radius of 2 mm at an equal angular interval of 360/7 degrees, i.e., around 51.4 degrees. The number 7 is obtained from the per 2000 value, i.e., 6.5 rounded off to the whole number. The seven small circles should be placed on the surface of the sphere on the basis of a definition of the existence probability. However, the drawing itself would not be easy. In addition, even if it might be possible for only a single sphere having a radius r=0.1, spheres having other radii drawn together in a concentric manner would cause inner spheres to be obstructed by outer ones, and as a result, situations on inner spheres could not clearly be seen. As a solution to this problem, circles having radii proportional to surface areas have been drawn in a concentric manner in ascending order of radius so that the outermost annular portion of a circle having each one of the radii can be seen at the same time. The method of expressing the per 2000 values only by use of the outermost annular portions will next be described with reference to FIG. 2B.

FIG. 2B displays 16 small circles 1 identical in shape and size with the ones displayed in FIG. 2A and placed at an equal angular interval of 360/16 degrees, i.e., around 22.5 degrees on a circumference of a circle having a radius of 6 mm inside a circle having a radius of around 8 mm which corresponds to a sphere having a radius r=0.2, and further displays 6 small circles 1 at an equal angular interval of 60 degrees on a circumference of a circle having a radius of 2 mm inside the above-described circle. The number 16 of the outer small circles 1 is the number shown in the sixth row (visible portion) and the third column (r=0.2). The number 6 of the inner small circles 1 is the remainder of subtraction of the number 16 shown in the sixth row (visible portion) and the third column from the number 22 which is obtained by rounding off the number 21.5 shown in the fifth row (per 2000) and the third column to the whole number.

This number 16 is obtained by subtracting, from the number 21.5 in the fifth row (per 2000) and the third column, the value obtained by multiplying the number 21.5 by a ratio of the surface area of a sphere 0.125 shown to the immediate left, i.e., in the second column to the surface area of a sphere 0.502 in the third column, and rounding off the result to the whole number, that is 16=21.5×(1−0.125/0.502). Since the circles are displayed together in a concentric manner, the central portion of a circle in the third column having a radius r=0.2 is hidden by a circle having a radius r=0.1 shown to the immediate left, i.e., in the second column. Therefore, a ratio of an area of the outer visible portion left without being hidden to the number of small circles 1 placed in the portion was set at the same value as the ratio of the per 2000 value 21.5 to the whole area of the circle 0.502. In FIG. 1, the inside of a circle having a radius of 4 mm placed slightly inside the outer portion is occupied by figures shown in FIG. 2A and only the outside of the circle is visible part in FIG. 2B.

FIG. 2C, similarly, displays 22 small circles 1 placed at an equal angular interval on a circumference of a circle having a radius of 10 mm in the outermost visible portion of the inside of a circle having a radius of around 12 mm and proportional in area to a surface area of a sphere having a radius r=0.3, 13 small circles 1 similarly at an equal angular interval on a circumference of a circle having a radius of 6 mm inside the above-described circle, and 5 small circles 1 at an equal angular interval on a circumference of a circle having a radius of 2 mm further inside. The summation of the numbers 13 and 5, i.e., 18, corresponds to the value obtained by subtracting the number 22 in the fourth row and the sixth column from the number 40 obtained by rounding off the number 39.5 in the same row and the fifth column to the whole number.

Although only three steps of the procedure shown in FIGS. 2A, 2B and 2C have been referred to, the similar steps are further iterated at an interval of r=0.1 as if FIGS. 2D, 2E and so on would follow up to r=3.0, while drawing corresponding figures with circles having larger radii placed together with and behind circles having smaller radii in a concentric manner, and decreasing their sizes to around ⅓ to finally obtain FIG. 1. The three concentric circles in FIG. 1 correspond to radii r=1, 2, and 3 in order of inner to outer ones. In FIG. 1, adjacent small circles 1 on the same circle having a small radius are displaced appropriately. For example, each of per 2000 values in visible portions at r=2.6, r=2.7 and r=2.8 is 2, and contains small circles 1 placed on a circle having the same radius located in the visible portions at an equal angular interval of 180 degrees, while angles between adjacent two inner or outer small circles have been determined in accordance with random number.

Operation and function of the educational tools configured as described above will now be described. Since Table1 covers radii from r=0.1 to around 7 at an interval of 0.1, the accumulative calculation in the fourth row corresponds to an (approximate) integration of an existence probability r² exp(−2r). The accumulated value converges into approximately 2.5 around r=7. The per 2000 values in the fifth row are obtained from the existence probabilities at respective radii divided by the converged value 2.5 and multiplied by 2000. Referring to any one of the per 2000 values as n, the values means that an electron, which exists singularly in the whole space, emerges in the vicinity of a corresponding radius at the probability of n times in 2000 times the unit time or the average revolving period.

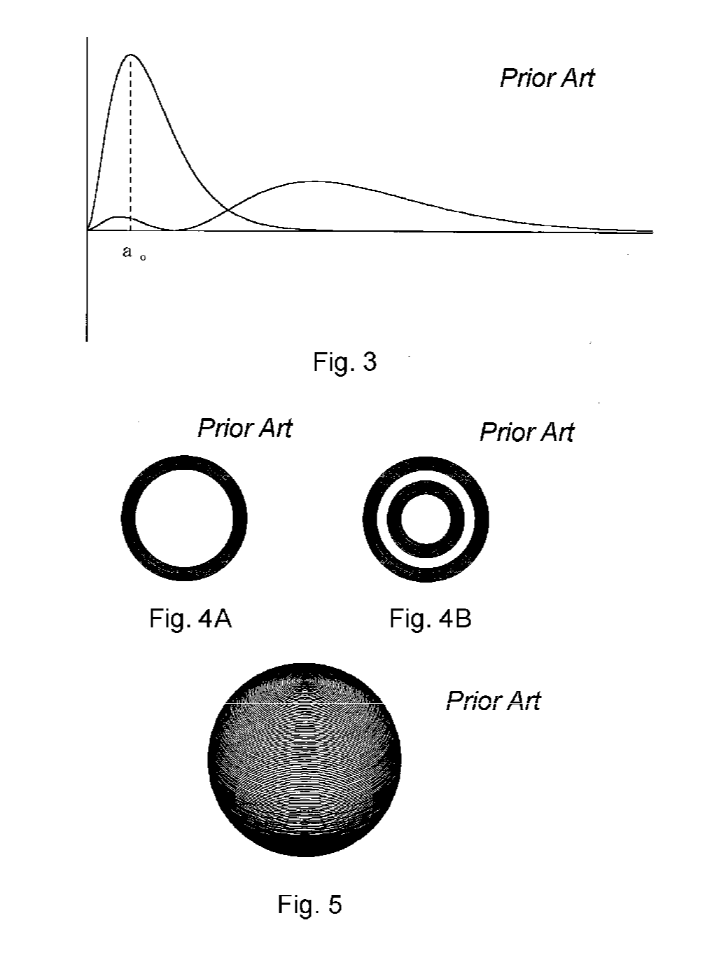

In FIG. 2A, since 7 small circles 1 which represent a per 2000 value are displayed, an electron emerges in the vicinity of the surface of a sphere having a radius r=0.1 at the probability of 7 times in the above-mentioned time. In FIG. 2B, since 22 small circles 1 are displayed, an electron emerges in the vicinity of the surface of a sphere having a radius r=0.2 at the probability of 22 times. In FIG. 2C, an electron emerges at the probability of 40 times. Among per 2000 values in Table 1, the value 108 for a radius r=1.0 is the highest. This result is consistent with the conventional graph in FIG. 3 which shows a maximum value at a radius r=1.0, as far as only that value 108 is compared.

Among 22 small circles 1 in FIG. 2B, 16 ones are placed along the circumference of an outer circle, and other 6 ones are along the circumference of an inner circle. Since the division by the ratio of 16 to 6 is identical with the area ratio of the visible outer portion to the hidden inner portion, the numbers of the small circles 1 per a unit area are the same between the two portions. Therefore, small circles 1 in the visible portion alone express an emerging probability per a unit area, i.e., the existence probability, over the whole region within a radius r=0.2. In FIG. 2B with FIG. 2A overlapped on the front thereof in a concentric manner, 7 small circles 1 can be seen in a central portion and 16 in the outside thereof. The small circles in both the portions express emerging probability per a unit area over the respective portions. FIG. 1 is obtained by overlapping FIGS. 2A and 2B on FIG. 2C and further on other drawings from r=0.4 to r=3.0 in a manner of one on another and reducing their sizes. Therefore, FIG. 1 can be said to express the three-dimensional extension of the existence probability in a 1s-orbital on a plane surface.

Next, advantageous effects will be described. As apparent from FIG. 1, it is found that the existence probability in a 1s-orbital increases with a decrease in a radius. Since, in the conventional drawing shown in FIG. 3, the existence probability r²exp(−2r) converges into zero as a radius approaches zero, it has been believed that an electron does not exist near the center of a 1s-orbital of a hydrogen atom, i.e., very near a proton. It can, however from the present example, be understood that the existence probability rather increases with a decrease in a distance from the center. FIG. 1 advantageously clarifies the fact hidden in the conventional graph that the existence probability of an electron is rather higher around the center.

In the conventional graph in FIG. 3, the surface area of a sphere as a domain of definition of the existence probability and the existence probability are multiplied by each other and unseparated. As a result, it can be said that only such a drastic change in the surface area of the sphere as to converge into zero at a rate of the square of a radius as the radius approaches zero has been brought to the fore, and the existence probability has instead been hidden behind. The present invention visualizes the change in the surface area of a sphere itself, expresses the existence probability defined on the surface of the sphere in connection with the surface area of the sphere, and as a result, allows the existence probability itself to be seen.

It should be noted that a three-dimensional existence probability can be expressed by use of the similar method also for a 2s-orbital and higher levels of s-orbitals, which is however omitted here. Other orbitals, such as p-orbitals, do not seem to be necessary for the present invention, and are not described here. Small circle 1 can be substituted by other small symbols, such as a small triangle and plus sign “+.” The per 2000 value can also be replaced with other numbers, such as per 1000 and 10000.

The example illustrated in FIG. 1 is a drawing on a plane surface. However, it can be said that a three-dimensional structure as an educational tool makes the existence probability more imageable. For example, there can be implemented such a method that multi-layered concentric spheres are formed of thin and transparent plastic films and small symbols 1 proportional in number to the existence probability are painted on the surfaces of the spheres in colors different from one radius to another. The colors are desired to be correlated with radii, such as a color being warmer with a decrease in a radius, and cooler with an increase in a radius.

As described above, the present invention advantageously reveals the three-dimensional distribution of the existence probability of an electron which has been hidden in conventional one-dimensional expressions, such as a graph shown in FIG. 3, and is expected to contribute to a change in and advancement of quantum mechanics.

### INDUSTRIAL APPLICABILITY

A method of displaying an existence probability of an electron in a hydrogen atom as an educational tool according to the present invention advantageously visualizes the quantitative distribution of the existence probability in the three-dimensional space, and useful for education and research.

### NOTATION OF SYMBOLS

1 small symbol (small circle).

1. A method of displaying an existence probability of an electron in a hydrogen atom, comprising:
displaying, with N radii referred to as r₁ to r_{N} in ascending order, and an area proportional to a surface area of a sphere having a radius rₙ (n is any of 1 to N) referred to as Sₙ, a circle having an area Sₙ for all n from 1 to N in a concentric manner; and
displaying, with a value proportional to an existence probability of an electron at a distance rₙ from a center of a hydrogen atom referred to as Pₙ, small symbols which are Pₙ in number on the circle having the area Sₙ in an equally spaced manner for all n from 1 to N and in such a manner that small symbols associated with a circle having a larger radius is hidden in part behind a circle having a smaller radius.
